(19) United States
(12) Patent Application Publication
(10) Pub. No.: US 2016/0223851 A1
(43) Pub. Date: Aug. 4, 2016

(54) DISPLAY DEVICE AND MANUFACTURING METHOD THEREOF

(71) Applicant: Samsung Display Co., Ltd., Yongin-City (KR)

(72) Inventors: Sun Hwa LEE, Yongin-si (KR); Sang-Uk LIM, Yongin-si (KR); Mee Hye JUNG, Suwon-si (KR)

(21) Appl. No.: 14/954,325

(22) Filed: Nov. 30, 2015

(30) Foreign Application Priority Data
Feb. 4, 2015 (KR) 10-2015-0017480

(51) Int. Cl. G02F 1/1347; G02F 1/1341; G02F 1/1333; G02F 1/1368

(52) U.S. Cl. CPC G02F 1/13475; G02F 1/1368; G02F 1/1341; G02F 1/133377; G02F 1/133345

(57) ABSTRACT

A display device includes: a substrate including a plurality of pixels formed in row and column directions; a thin film transistor disposed on the substrate, and a pixel electrode connected to the thin film transistor; a first liquid crystal layer filled inside a microcavity formed on the pixel electrode; a plurality of roof layers formed to be separated from the pixel electrode with the microcavity and an injection hole therebetween; and an overcoat formed on the roof layer to cover the injection hole and encapsulate the microcavity. The first liquid crystal layer includes a liquid crystal molecule and a color material. It is possible to simplify a structure of the display device and reduce the number of manufacturing processes thereof by adding a color material to a liquid crystal material of the display device manufactured with a single substrate such that a color filter may be removed.

### CLAIM OF PRIORITY

This application makes reference to, incorporates the same herein, and claims all benefits accruing under 35 U.S.C. §119 from an application earlier filed in the Korean Intellectual Property Office on 4 Feb. 2015 and there duly assigned Serial No. 10-2015-0017480.

### BACKGROUND OF THE INVENTION

1. Field of the Invention

The present invention relates to a display device in which a color filter is not included, and a manufacturing method thereof.

2. Description of the Related Art

As one of the most widely used flat panel display devices recently, a liquid crystal display (LCD) device includes two display panels on which field generating electrodes such as a pixel electrode and a common electrode are formed, and a liquid crystal layer interposed between the two display panels. The LCD displays an image by generating an electric field on a liquid crystal layer by applying a voltage to the field generating electrodes, determining alignment directions of liquid crystal molecules of the liquid crystal layer by the generated field, and controlling polarization of incident light.

Two sheets of display panels of which the LCD consists may include a thin film transistor array panel and an opposing display panel. In the thin film transistor array panel, a gate line for transmitting a gate signal and a data line for transmitting a data signal are formed to cross each other, and a thin film transistor connected to the gate and data lines, a pixel electrode connected to the thin film transistor, and the like may be formed. In the opposing display panel, a light blocking member, a color filter, a common electrode, and the like may be formed. In some embodiments, the light blocking member, the color filter, and the common electrode may be formed on the thin film transistor array panel.

However, in conventional LCDs, two substrates are required and constituent elements are respectively formed on the two substrates, thereby requiring a long processing time as well as making the display device heavy, thick, and costly.

Recently, a technique in which a plurality of microcavities of a tunnel-shape structure are formed on one substrate and the liquid crystal is injected inside the structure to manufacture the display device has been developed. A color filter included in the display device is typically formed between the substrate and the microcavities, or is formed on the microcavities.

The above information disclosed in this Background section is only for enhancement of understanding of the background of the invention and therefore it may contain information that does not form the prior art that is already known in this country to a person of ordinary skill in the art.

### SUMMARY OF THE INVENTION

The present invention has been made in an effort to provide a display device and a manufacturing method thereof that may simplify a structure thereof and may reduce the number of manufacturing steps thereof by adding a color material to a liquid crystal material of a display device manufactured with a single substrate such that a color filter may be eliminated.

An exemplary embodiment of the present invention provides a display device, and the display device includes: a substrate including a plurality of pixels formed in row and column directions; a thin film transistor disposed on the substrate, and a pixel electrode connected to the thin film transistor; a first liquid crystal layer filled inside a microcavity formed on the pixel electrode; a plurality of roof layers formed to be separated from the pixel electrode with the microcavity and an injection hole therebetween; and an overcoat formed on the roof layer to cover the injection hole and encapsulate the microcavity. The first liquid crystal layer includes a liquid crystal molecule and a color material.

The color material may include a red, green, or blue pigment.

First liquid crystal layers that are adjacent in a row direction may include different color pigments, and first liquid crystal layers that are adjacent in a column direction may include the same color pigment.

The pigment may include an inorganic or organic pigment.

A second liquid crystal layer containing only liquid crystal molecules may be further included in the display device. The second liquid crystal layer may display a white color.

The color material may include a dichroic dye having predetermined anisotropy.

The dichroic dye may include a material absorbing a wavelength region corresponding to one of cyan, magenta, yellow, red, green, and blue.

The dichroic dye may include one or more selected from azo dyes, anthraquinone dyes, perylene dyes, merocyanine dyes, azomethine dyes, phthaloperylene dyes, indigo dyes, dioxadine dyes, polythiophene dyes, and phenoxazine dyes.

The color material may include a material that transmits light having a red, green, or blue wavelength, and reflect light having other wavelengths.

Another embodiment of the present invention provides a manufacturing method of a display device, and method includes steps of: forming a thin film transistor on a substrate; forming a pixel electrode connected to the thin film transistor on the thin film transistor; forming a sacrificial layer on the pixel electrode; forming a roof layer that includes an injection hole formed by coating and patterning an organic material on the sacrificial layer; forming a microcavity between the roof layer and the pixel electrode by removing the sacrificial layer; forming a first liquid crystal layer by injecting a first liquid crystal material in the microcavity through the injection hole; and forming an overcoat on the roof layer to cover the injection hole and encapsulate the microcavity. The first liquid crystal material includes a liquid crystal molecule and a color material.

The manufacturing method may further include forming a common electrode on the sacrificial layer before forming the sacrificial layer and the roof layer.

According to the embodiment of the present invention, it is possible to simplify a structure of the display device and may reduce the number of manufacturing steps thereof by adding a color material to a liquid crystal material of the display device manufactured with a single substrate such that a color filter may be eliminated.

### BRIEF DESCRIPTION OF THE DRAWINGS

A more complete appreciation of the invention, and many of the attendant advantages thereof, will be readily apparent as the same becomes better understood by reference to the following detailed description when considered in conjunction with the accompanying drawings in which like reference symbols indicate the same or similar components, wherein:

FIG. 1 is a layout view of one pixel of a display device according to an exemplary embodiment of the present invention.

FIG. 2 is a cross-sectional view of FIG. 1 taken along line II-II.

FIG. 3 is a cross-sectional view of FIG. 1 taken along line III-III.

FIGS. 4, 6, 8, 10, and 12 are cross-sectional views of FIG. 1 taken along line II-II according to manufacturing processes for a display device of an exemplary embodiment of the present invention.

FIGS. 5, 7, 9, 11, and 13 are cross-sectional views of FIG. 1 taken along line III-III according to manufacturing processes for a display device of an exemplary embodiment of the present invention.

### DETAILED DESCRIPTION OF THE EMBODIMENTS

The present invention will be described more fully hereinafter with reference to the accompanying drawings, in which exemplary embodiments of the invention are shown. As those skilled in the art would realize, the described embodiments may be modified in various different ways, all without departing from the spirit or scope of the present invention.

In the drawings, the thickness of layers, films, panels, regions, etc., are exaggerated for clarity. Like reference numerals designate like elements throughout the specification. It will be understood that when an element such as a layer, film, region, or substrate is referred to as being “on” another element, it can be directly on the other element or intervening elements may also be present. In contrast, when an element is referred to as being “directly on” another element, there are no intervening elements present.

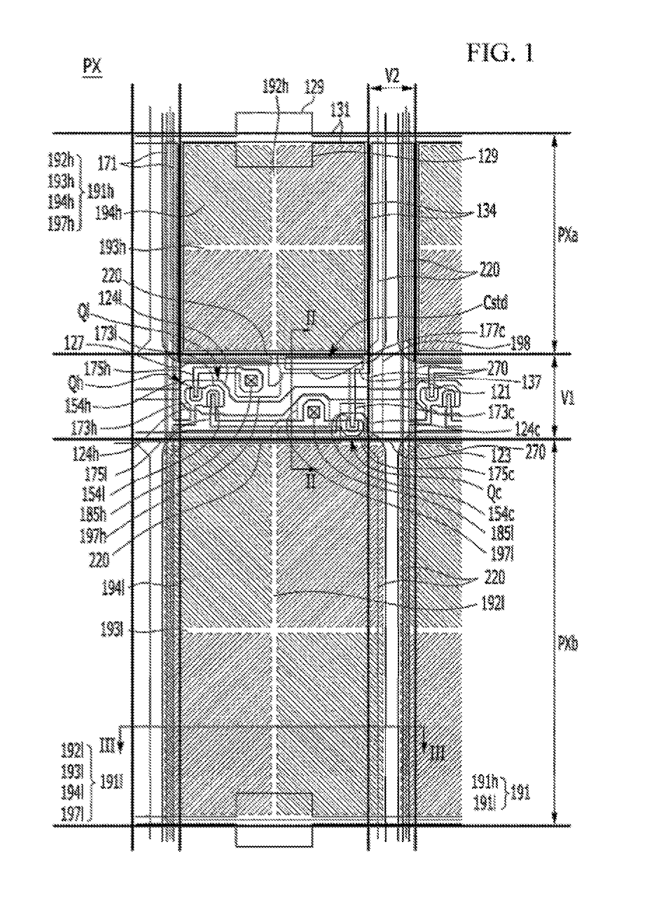

First, a display device according to an exemplary embodiment of the present invention will now be described with reference to FIGS. 1 to 3.

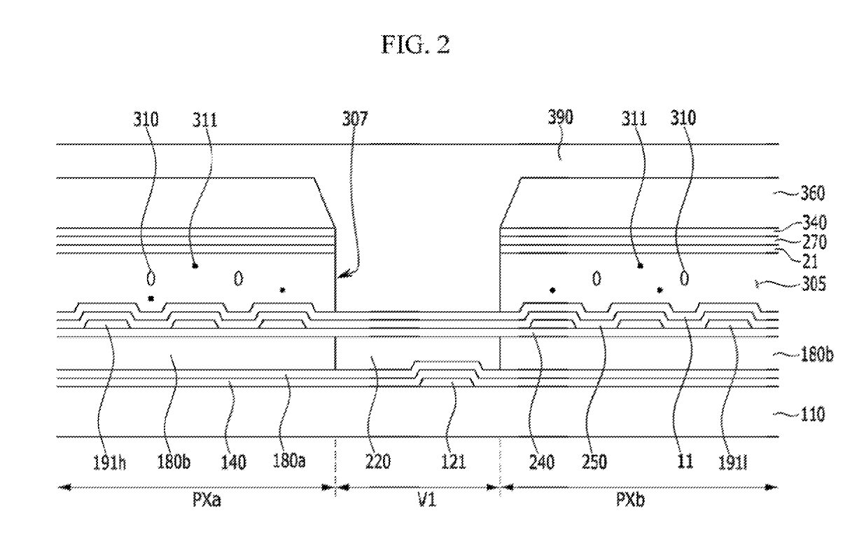

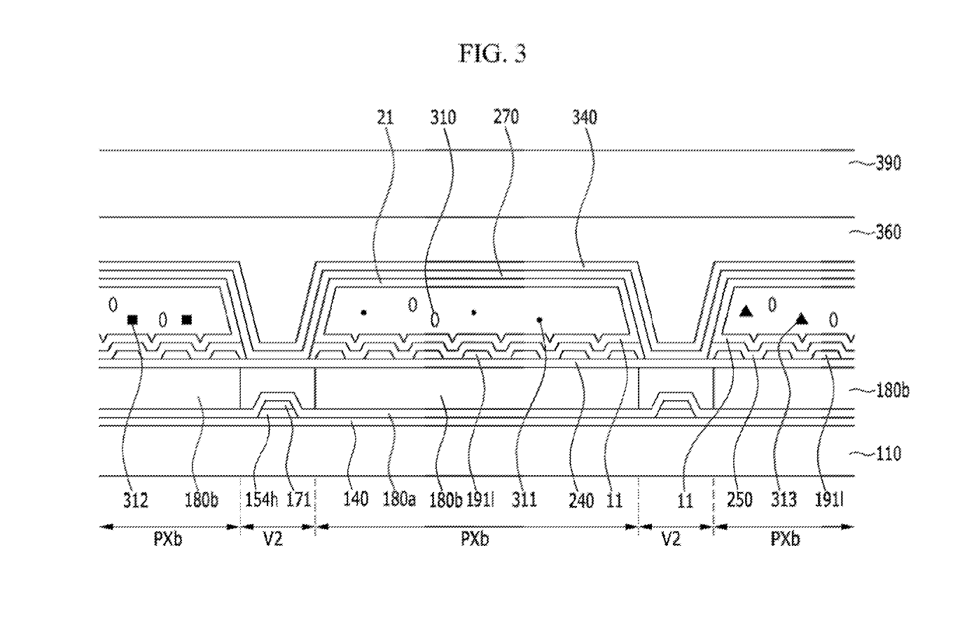

FIG. 1 is a layout view of one pixel of a display device according to an exemplary embodiment of the present invention, FIG. 2 is a cross-sectional view of FIG. 1 taken along line II-II, and FIG. 3 is a cross-sectional view of FIG. 1 taken along line III-III.

The liquid crystal display according to the exemplary embodiment of the present invention includes an insulation substrate 110 made of a material such as glass or plastic, and a roof layer 360 formed on the insulation substrate 110.

A plurality of pixels PX are disposed on the insulation substrate 110. The pixels PX are disposed in a matrix form which includes a plurality of pixel columns and a plurality of pixel rows. One pixel PX is a region overlapped with one pixel electrode, and may include, for example, a first subpixel PXa and a second subpixel PXb. The first subpixel PXa is overlapped with a first subpixel electrode 191h, and the second subpixel PXb is overlapped with the second subpixel electrode 191l. The first subpixel PXa and the second subpixel area PXb may be disposed in a vertical direction that is an extension direction of a data line.

A first valley V1 is disposed between the first subpixel PXa and the second subpixel PXb along an extension direction of a gate line, and a second valley V2 is disposed between columns of the adjacent pixel areas.

The roof layer 360 is formed in the extension direction of the data line. In this case, an injection hole 307 is formed in the first valley V1 by removing the roof layer 360 so that constituent elements disposed below the roof layer 360 may be exposed.

Each roof layer 360 is formed to be spaced apart from the substrate 110 between the adjacent second valleys V2 to form a microcavity 305. Further, each roof layer 360 is formed to be attached to the substrate 110 in the second valley V2 to cover opposite lateral surfaces of the microcavity 305.

The structure of the display device according to the exemplary embodiment of the present invention described above is just an example, and may be variously modified. For example, arrangement of the pixel PX, the first valley V1, and the second valley V2 may be modified, the roof layers 360 may be connected to each other in the first valley V1, and each roof layer 360 may be formed to be partially separated from the substrate 110 in the second valley V2 such that the adjacent microcavities 305 may be connected to each other.

In reference to FIGS. 1-3, a plurality of gate conductors including a plurality of gate lines 121, a plurality of step-down gate lines 123, and a plurality of storage electrode lines 131 are disposed on an insulation substrate 110.

The gate line 121 and the step-down gate line 123 mainly extend in a horizontal direction to transmit gate signals. The gate conductor further includes a first gate electrode 124h and a second gate electrode 124l protruding upward and downward from the gate line 121, and further includes a third gate electrode 124c protruding upward from the step-down gate line 123. The first gate electrode 124h and second gate electrode 124l are connected with each other to form one protrusion. In this case, respective protruded shapes of the first, second, and third gate electrodes 124h, 124l, and 124c may be modified.

The storage electrode line 131 mainly extends in a horizontal direction and transmits a predetermined voltage such as a common voltage Vcom. The storage electrode line 131 includes storage electrodes 129 protruding upward and downward, a pair of vertical portions 134 extending downward to be substantially vertical to the gate line 121, and a horizontal portion 127 connecting ends of the pair of vertical portions 134. The horizontal portion 127 includes a capacitive electrode 137 extended downward.

A gate insulating layer 140 is disposed on the gate conductors 121, 123, 124h, 124l, 124c, and 131. The gate insulating layer 140 may be made of an inorganic insulating material such as a silicon nitride (SiNx) and a silicon oxide (SiOx). Further, the gate insulating layer 140 may be formed as a single layer or multilayers.

A first semiconductor layer 154h, a second semiconductor layer 154l, and a third semiconductor layer 154c are disposed on the gate insulating layer 140. The first semiconductor layer 154h may be disposed on the first gate electrode 124h, the second semiconductor layer 154l may be disposed on the second gate electrode 124l, and the third semiconductor layer 154c may be disposed on the third gate electrode 124c. The first semiconductor layer 154h and the second semiconductor layer 154l may be connected to each other, and the second semiconductor layer 154l and the third semiconductor layer 154c may be connected to each other. Further, the first semiconductor layer 154h may be formed to be extended to the lower portion of the data line 171. The first, second, and third semiconductor layers 154h, 154l, and 154c may be made of amorphous silicon, polycrystalline silicon, a metal oxide, and the like.

Ohmic contacts (not illustrated) may be further disposed on the first, second, and third semiconductors 154h, 154l, and 154c, respectively. The ohmic contact may be made of silicide or a material such as n+hydrogenated amorphous silicon in which an n-type impurity is doped at a high concentration.

A data conductor including a data line 171, a first source electrode 173h, a second source electrode 173l, a third source electrode 173c, a first drain electrode 175h, a second drain electrode 175l, and a third drain electrode 175c is disposed on the first, second, third semiconductor layers 154h, 154l, and 154c.

The data line 171 transmits a data signal and mainly extends in a vertical direction to cross the gate line 121 and the step-down gate line 123. Each data line 171 extends toward the first gate electrode 124h and the second gate electrode 124l, and includes the first source electrode 173h and the second source electrode 173l which are connected with each other.

Each of the first drain electrode 175h, the second drain electrode 175l, and the third drain electrode 175c includes one wide end portion and the other rod-shaped end portion. The rod-shaped end portions of the first drain electrode 175h and the second drain electrode 175lare partially surrounded by the first source electrode 173h and the second source electrode 173l, respectively. One wide end portion of the second drain electrode 175l is further extended to form the third drain electrode 175c that is bent in a ‘U’-letter shape. A wide end portion 177c of the third drain electrode 175c overlaps with the capacitive electrode 137 to form a step-down capacitor Cstd, and the rod-shaped end portion is partially surrounded by the third source electrode 173c.

The first gate electrode 124h, the first source electrode 173h, and the first drain electrode 175h form a first thin film transistor Qh together with the first semiconductor layer 154h, the second gate electrode 124l, the second source electrode 173l, and the second drain electrode 175l form a second thin film transistor Ql together with the second semiconductor layer 154l, and the third gate electrode 124c, the third source electrode 173c, and the third drain electrode 175c form the third thin film transistor Qc together with the third semiconductor layer 154c.

The first semiconductor layer 154h, the second semiconductor layer 154l, and the third semiconductor layer 154c are connected to each other to form a linear shape, and may have substantially the same planar shape as the data conductors 171, 173h, 173l, 173c, 175h, 175l, and 175c and the ohmic contacts therebelow, except at channel regions between the source electrodes 173h, 173l, and 173c and the drain electrodes 175h, 173l, and 175c.

In the first semiconductor layer 154h, an exposed portion which is not covered by the first source electrode 173h and the first drain electrode 175h is disposed between the first source electrode 173h and the first drain electrode 175h. In the second semiconductor layer 154l, an exposed portion which is not covered by the second source electrode 173l and the second drain electrode 175l is disposed between the second source electrode 173l and the second drain electrode 175l. In addition, in the third semiconductor layer 154c, an exposed portion which is not covered by the third source electrode 173c and the third drain electrode 175c is disposed between the third source electrode 173c and the third drain electrode 175c.

A first passivation layer 180a is disposed on the data conductors 171, 173h, 173l, 173c, 175h, 175l, and 175c and the semiconductor layers 154h, 154l, and 154c exposed between the respective source electrodes 173h, 173l, and 173c and the respective drain electrodes 175h, 175l, and 175c. The first passivation layer 180a may be made of an organic insulating material or an inorganic insulating material, and may be formed as a single layer or multilayers.

Next, a second passivation layer 180b and a light blocking member 220 are disposed on the first passivation layer 180a.

The light blocking member 220 is disposed in a region at which the thin film transistor is disposed. The light blocking member 220 is disposed on a boundary portion of the pixel PX and on the thin film transistor to prevent light leakage thereon. The second passivation layer 180b may be disposed in each of the first subpixel PXa and the second subpixel PXb, and the light blocking member 220 may be disposed in the first subpixel PXa and the second subpixel PXb.

The light blocking member 220 extends along an extending direction of the gate line 121 and the step-down gate line 123 to be extended upward and downward. The light blocking member 220 may cover a region in which the first thin film transistor (Qh), the second thin film transistor (Ql), and the third thin film transistor (Qc) are disposed, or may extend along the data line 171. In other words, the light blocking member 220 may be disposed in the first valley V1 and the second valley V2. The second passivation layer 180b and the light blocking member 220 may be partially overlapped with each other.

In the first passivation layer 180a, the second passivation layer 180b, and the light blocking member 220, a plurality of first contact holes 185h and a plurality of second contact holes 185l are formed to expose the wide end portion of the first drain electrode 175h and the wide end portion of the second drain electrode 175l.

A first insulating layer 240 is disposed on the second passivation layer 180b and the light blocking member 220, and a pixel electrode 191 is disposed on the first insulating layer 240. The pixel electrode 191 may be made of a transparent metal material such as indium tin oxide (no) and indium zinc oxide (IZO).

The pixel electrode 191 includes a first subpixel electrode 191h and a second subpixel electrode 191l that are separated from each other with the gate line 121 and the step-down gate line 123 therebetween and disposed above and below the pixel PX based on the gate line 121 and the step-down gate line 123 to be adjacent to each other in the extending direction of the data line. In other words, the first subpixel electrode 191h and the second subpixel electrode 191l are separated from each other with the first valley V1 therebetween, the first subpixel electrode 191h is disposed in the first subpixel PXa, and the second subpixel electrode 191l is disposed in the second subpixel PXb.

The first subpixel electrode 191h and the second subpixel electrode 191l are connected to the first drain electrode 175h and the second drain electrode 175l through the first contact hole 185h and the second contact hole 185l, respectively. Accordingly, when the first thin film transistor Qh and the second thin film transistor Ql are turned on, the first thin film transistor Qh and the second thin film transistor Ql receive data voltages from the first drain electrode 175h and the second drain electrode 175l.

An overall shape of each of the subpixel electrode 191h and the second subpixel electrode 191l is a quadrangle, and the subpixel electrode 191h and the second subpixel electrode 191l include cross stems including horizontal stems 193h and 193l and vertical stems 192h and 192l crossing the horizontal stems 193h and 193l, respectively. Further, the first subpixel electrode 191h and the second subpixel electrode 191l include a plurality of minute branches 194h and 194l, and projections 197h and 197l protruding downward or upward from edge sides of the subpixel electrodes 194h and 194l, respectively.

The pixel electrode 191 is divided into four subregions by the horizontal stems 193h and 193l and the vertical stems 192h and 192l. The minute branches 194h and 194l obliquely extend from the horizontal stems 193h and 193l and the vertical stems 192h and 192l, and the extending direction thereof may form an angle of about 45° or 135° with the gate line 121 or the horizontal stems 193h and 193l. Further, extending directions of the minute branches 194h and 194l of the two adjacent subregions may be perpendicular to each other.

In the exemplary embodiment, the first subpixel electrode 191h further includes an outer stem surrounding the outside, and the second subpixel electrode 191l further includes horizontal portions disposed at an upper end and a lower end, and left and right vertical portions 198 disposed at left and right sides of the first subpixel electrode 191h. The left and right vertical portions 198 may prevent capacitive coupling, that is, coupling between the data line 171 and the first subpixel electrode 191h.

The layout form of the pixel, the structure of the thin film transistor, and the shape of the pixel electrode described above are just exemplified, and the present invention is not limited thereto and may be variously modified.

A second insulating layer 250 is disposed on the pixel electrode 191, and a common electrode 270 is disposed on the pixel electrode 191 to be spaced apart from the pixel electrode 191 by a predetermined distance. A microcavity 305 is formed between the pixel electrode 191 and the common electrode 270. In other words, the microcavity 305 is surrounded by the pixel electrode 191 and the common electrode 270, and is differentiated per one pixel. A width and an area of the microcavity 305 may be variously modified according to a size and resolution of the display device.

The common electrode 270 may be made of a transparent metal material such as indium tin oxide (ITO) and indium zinc oxide (IZO). A predetermined voltage may be applied to the common electrode 270, and an electric field may be generated between the pixel electrode 191 and the common electrode 270.

A first alignment layer 11 is formed on the second insulating layer 250. A second alignment layer 21 is disposed below the common electrode 270 to face the first alignment layer 11.

The first alignment layer 11 and the second alignment layer 21 may be formed with vertical alignment layers and made of alignment materials such as polyamic acid, polysiloxane, and polyimide. The first and second alignment layers 11 and 21 may be connected to each other at the edge of the pixel PX.

A liquid crystal layer made of liquid crystal molecules 310 is formed in the microcavity 305 disposed between the pixel electrode 191 and the common electrode 270. The liquid crystal molecules 310 have negative dielectric anisotropy, and may stand up in a direction perpendicular to the substrate 110 while the electric field is not applied. That is, the liquid crystal molecules 310 may be vertically aligned.

The liquid crystal layer of the display device according to the exemplary embodiment of the present invention includes a liquid crystal material including the liquid crystal molecules 310 and color materials 311, 312, and 313 mixed with the liquid crystal material. The color materials 311, 312, and 313 are mixed with the liquid crystal material, and each of the color materials 311, 312, and 313 may be a pigment representing at least one of primary colors of red, green, and blue.

Accordingly, the pigments 311, 312, and 313 with different colors are respectively applied to the microcavities 305, such that light passing through each of the microcavities 305 may represent a color corresponding to each of the pigments 311, 312, and 313. That is, when colors of the pigments 311, 312, and 313 are respectively red, green, and blue, the liquid crystal layers included in the microcavities 305 may respectively represent the red, green, and blue colors.

The pigments 311, 312, and 313 may be an inorganic pigment or an organic pigment, but are not limited thereto, and thus may be any pigment that is able to represent a predetermined color.

Further, a microcavity 305 representing a white color may be formed by not including any of the pigments 311, 312, and 313.

The color materials 311, 312, and 313 may include dichroic dyes having anisotropy in absorption of light, instead of the pigments with the colors described above.

Colors represented by the dichroic dyes 311, 312, and 313 are determined by a spectrum with respect to colors that are not absorbed by the dichroic dyes 311, 312, and 313, that is, complementary colors. Accordingly, when any pixel is intended to display one of primary colors of red, green, and blue, the dichroic dye 311, 312, or 313 included in the liquid crystal layer corresponding to the pixel may be a material absorbing light of a wavelength region corresponding to one of cyan, magenta, and yellow. For example, each of liquid crystal layers corresponding to a red pixel, a green pixel, and a blue pixel may include a liquid crystal material in which a cyan dichroic dye, a magenta dichroic dye, and yellow dichroic dye 311, 312, and 313 are respectively mixed. In this case, the cyan dichroic dye may absorb light of a wavelength region of 600-700 nm, the magenta dichroic dye may absorb light of a wavelength region of 500-580 nm, and the yellow dichroic dye may absorb light of a wavelength region of 430-490 nm.

Unlike this, when any pixel displays one of cyan, magenta, and yellow, the dichroic dye 311, 312, or 313 included in the liquid crystal layer corresponding to the pixel may be a material absorbing light of a wavelength region corresponding to one of red, green, and blue.

Further, a microcavity 305 representing a white color may be formed by including the pigments 311, 312, and 313 with only primary colors of red, green, and blue.

The dichroic dyes 311, 312, and 313, for example, may include one or more selected from azo dyes, anthraquinone dyes, perylene dyes, merocyanine dyes, azomethine dyes, phthaloperylene dyes, indigo dyes, dioxadine dyes, polythiophene dyes, and phenoxazine dyes, but are not limited thereto.

An appropriate concentration of the dichroic dyes 311, 312, and 313 mixed with the liquid crystal material may be varied depending on an absorption capacity of light of the dichroic dyes 311, 312, and 313.

The dyes 311, 312, and 313 are not limited to those described above, and may include materials which pass through light of some specific wavelengths and which reflect light of the other wavelengths. In other words, a liquid crystal layer filled inside a microcavity 305 corresponding to a pixel representing a red color may include a material that passes through only light of a red wavelength band and reflects light of the remaining wavelength band. Further, a liquid crystal layer filled inside a microcavity 305 corresponding to a pixel representing a green color may include a material that passes through only light of a green wavelength band and reflects light of the remaining wavelength band. In addition, a liquid crystal layer filled inside a microcavity 305 corresponding to a pixel representing a blue color may include a material that passes through only light of a blue wavelength band and reflects light of the remaining wavelength band.

According to the exemplary embodiment of the present invention, since the color of the pixel is implemented by the color pigment or the dichroic color dye that is included in the liquid crystal layer, or by the material that passes through light of some specific wavelengths, a color filter is not required. Accordingly, a photolithography process for forming the color filter is not required, thereby simplifying a structure of the display device, and reducing manufacturing processes, time, and cost.

The first subpixel electrode 191h and the second subpixel electrode 191l to which the data voltage is applied generate an electric field together with the common electrode 270 to determine directions of the liquid crystal molecules 310 of the microcavity 305 between the two electrodes 191 and 270. As such, luminance of light passing through the liquid crystal layer varies according to the determined directions of the liquid crystal molecules 310.

A third insulating layer 340 may be further formed on the common electrode 270. The third insulating layer 340 may be made of an inorganic insulating material such as a silicon nitride (SiNx), a silicon oxide (SiOx), and a silicon nitride oxide (SiOxNy), and may be removed if necessary.

A roof layer 360 is formed on the third insulating layer 340, and may be made of an organic material. The microcavity 305 is formed below the roof layer 360, and the roof layer 360 is hardened by a curing process to maintain a shape of the microcavity 305. That is, the roof layer 360 is formed to be spaced apart from the pixel electrode 191 with the microcavity 305 therebetween.

The roof layer 360 is formed in each pixel PX and the second valley V2 along an extending direction of the data line, and is not formed in the first valley V1. That is, the roof layer 360 is not formed between the first subpixel area PXa and the second subpixel area PXb. The microcavity 305 is formed below each roof layer 360 in the first subpixel PXa and the second subpixel PXb. In the second valley V2, the microcavity 305 is not formed below the roof layer 360, but is formed to be attached to the substrate 110. Accordingly, a thickness of the roof layer 360 disposed at the second valley V2 may be larger than a thickness of the roof layer 360 disposed in the first subpixel PXa or the second subpixel PXb. An upper surface and both sides of the microcavity 305 are formed to be covered by the roof layer 360.

An injection hole 307 exposing a portion of the microcavity 305 is formed in the common electrode 270, the third insulating layer 340, and roof layer 360. The injection holes 307 may be formed to face each other at the edge of the first subpixel PXa and the second subpixel PXb. For example, the injection holes 307 may be formed at a lower side of the first subpixel PXa and an upper side of the second subpixel PXb to expose lateral surfaces of the microcavity 305. Since the microcavity 305 is exposed through the injection hole 307, an aligning agent or a liquid crystal material may be injected into the microcavity 305 through the injection hole 307.

An overcoat 390 is disposed on the roof layer 360. The overcoat 390 covers the injection hole 307 that exposes a portion of the microcavity 305 to the outside. The overcoat 390 seals the microcavity 305 such that the liquid crystal molecules 310 contained in the microcavity 305 may not be discharged outside. Since the overcoat 390 contacts the liquid crystal molecules 310, the overcoat 390 may be made of a material that does not react with the liquid crystal molecules 310.

The overcoat 390 may be formed to cover the entire surface of the substrate 110.

Although not illustrated, polarizers may be further formed on the upper and lower surfaces of the display device. The polarizers may be formed as a first polarizer and a second polarizer. The first polarizer may be attached to the lower surface of the substrate 110, and the second polarizer may be attached to the overcoat 390.

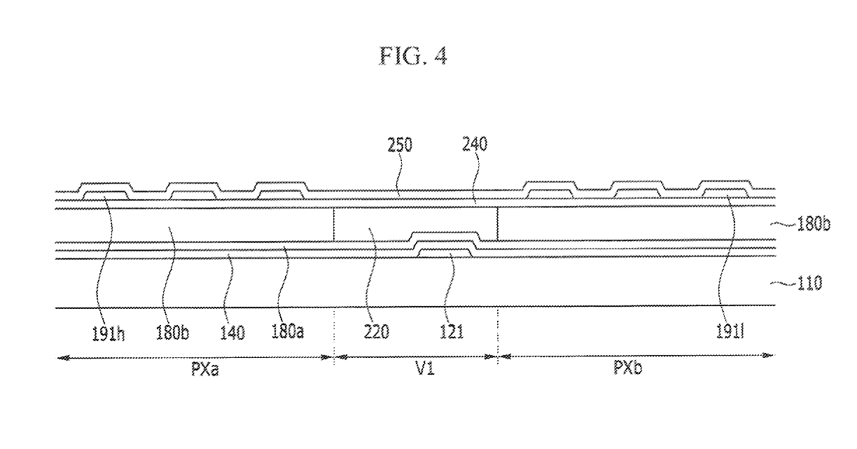

A manufacturing method of the display device according to the exemplary embodiment of the present invention will now be described with reference to FIGS. 4 to 13.

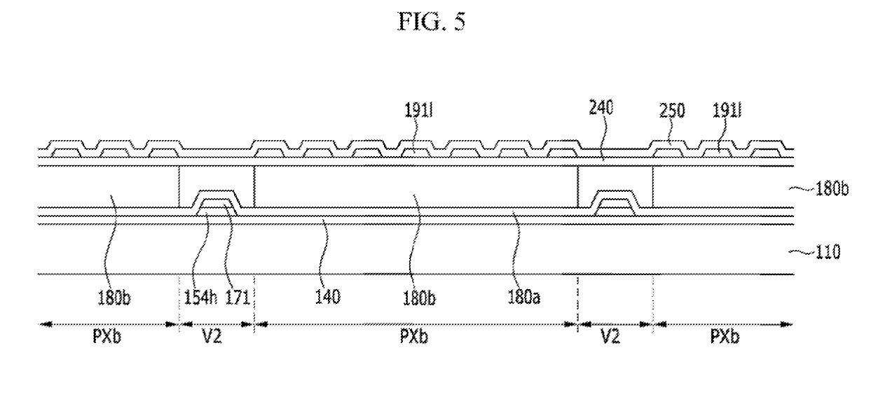

FIGS. 4, 6, 8, 10, and 12 are cross-sectional views of FIG. 1 taken along line II-II according to manufacturing processes for the display device of the exemplary embodiment of the present invention, and FIGS. 5, 7, 9, 11, and 13 are cross-sectional views of FIG. 1 taken along line III-III according to manufacturing processes for the display device of the exemplary embodiment of the present invention.

First, as shown in FIGS. 4 and 5, a gate line 121 and a step-down gate line 123 that extend in one direction are formed on a substrate 110 that is formed of glass or plastic, and a first gate electrode 124h, a second gate electrode 124l, and a third gate electrode 124c are formed to protrude from the gate line 121.

Further, a storage electrode line 131 may be formed together to be spaced apart from the gate line 121, the step-down gate line 123, and the first, second, and third gate electrodes 124h, 124l, and 124c.

Next, a gate insulating layer 140 is formed on the entire surface of the substrate 110 including the gate line 121, the step-down gate line 123, the first, second, and third gate electrodes 124h, 124l, and 124c, and the storage electrode 131 by using an inorganic insulating material such as a silicon oxide (SiOx) or a silicon nitride (SiNx). The gate insulating layer 140 may be formed with a single layer or multilayers.

Next, a first semiconductor layer 154h, a second semiconductor layer 154l, and a third semiconductor layer 154c are formed by depositing a semiconductor material such as amorphous silicon, polycrystalline silicon, and a metal oxide on the gate insulating layer 140 and then patterning the deposited semiconductor material. The first semiconductor layer 154h may be disposed on the first gate electrode 124h, the second semiconductor layer 154l may be disposed on the second gate electrode 124l, and the third semiconductor layer 154c may be disposed on the third gate electrode 124c.

Next, a data line 171 extending in the other direction is formed by depositing a metal material and then patterning the deposited metal material. The metal material may be formed as a single layer or multilayers.

Further, a first source electrode 173h protruding upward the first gate electrode 124h from the data line 171 and a first drain electrode 175h spaced apart from the first source electrode 173h are formed together. Further, a second source electrode 173l connected with the first source electrode 173h and a second drain electrode 175l spaced apart from the second source electrode 173l are formed together. Further, a third source electrode 173c extended from the second drain electrode 175l and a third drain electrode 175c spaced apart from the third source electrode 173c are formed together.

The first, second, and third semiconductor layers 154h, 154l, and 154c, the data line 171, the first, second, and third source electrodes 173h, 173l, and 173c, and the first, second, and third drain electrodes 175h, 175l, and 175c may be formed by sequentially depositing a semiconductor material and a metal material and simultaneously patterning the semiconductor material and the metal material. In this case, the first semiconductor layer 154h may be extended to the lower portion of the data line 171.

The first, second, and third gate electrodes 124h, 124l, and 124c, the first, second, and third source electrodes 173h, 173l, and 173c, and the first, second, and third drain electrodes 175h, 175l, and 175c form first, second, and third thin film transistors (TFTs) Qh, Ql, and Qc together with the first, second, and third semiconductor layers 154h, 154l, and 154c, respectively.

Next, a first passivation layer 180a is formed on the data line 171, the first, second, and third source electrodes 173h, 173l, and 173c, the first, second, and third drain electrodes 175h, 175l, and 175c, and the semiconductor layers 154h, 154l, and 154c exposed between the respective source electrodes 173h, 173l, and 173c and the respective drain electrodes 175h, 175l, and 175c. The first passivation layer 180a may be made of an organic insulating material or an inorganic insulating material, and may be formed with a single layer or multilayers.

Next, a second passivation layer 180b is formed to be disposed in respective pixels PX above the first passivation layer 180a. The second passivation layer 180b may be formed in the first subpixel PXa or the second subpixel PXb, and may not be formed in the first valley V1.

Next, a light blocking member 220 is formed on each boundary portion of the pixels PX above the first passivation layer 180a, and on the thin film transistors. The light blocking member 220 may also be formed in the first valley V1 disposed between the first subpixel PXa and the second subpixel PXb.

Hereinabove, it is described that the light blocking member 220 is formed after forming the second passivation layer 180b, but the present invention is not limited thereto, and the light blocking member 220 may be first formed and then the second passivation layer 180b may be formed.

Next, a first insulating layer 240 made of an inorganic insulating material such as a silicon nitride (SiNx), a silicon oxide (SiOx), and a silicon nitride oxide (SiOxNy) is formed on the second passivation layer 180b and the light blocking member 220.

Next, a first contact hole 185h is formed by etching the first passivation layer 180a, the light blocking member 220, and the first insulating layer 240 to expose a portion of the first drain electrode 175h, and a second contact hole 185l is formed to expose a portion of the second drain electrode 175l.

Next, a first subpixel electrode 191h is formed in the first subpixel PXa and a second subpixel electrode 191l is formed in the second subpixel PXb by depositing and patterning a transparent metal material such as indium tin oxide (ITO) and indium zinc oxide (IZO) on the first insulating layer 240. The first subpixel electrode 191h and the second subpixel electrode 191l are separated from each other with the first valley V1 therebetween. The first subpixel electrode 191h is connected with the first drain electrode 175h through the first contact hole 185h, and the second subpixel electrode 191l is connected with the second drain electrode 175l through the second contact hole 185l.

Horizontal stems 193h and 193l and vertical stems 192h and 192l crossing the horizontal stems 193h and 193l are formed in the first subpixel electrode 191h and the second subpixel electrode 191l, respectively. Further, a plurality of minute branches 194h and 194l are formed to obliquely extend from the horizontal stems 193h and 193l and the vertical stems 192h and 192l.

Next, a second insulating layer 250 is formed on the pixel electrode 191 and the first insulating layer 240.

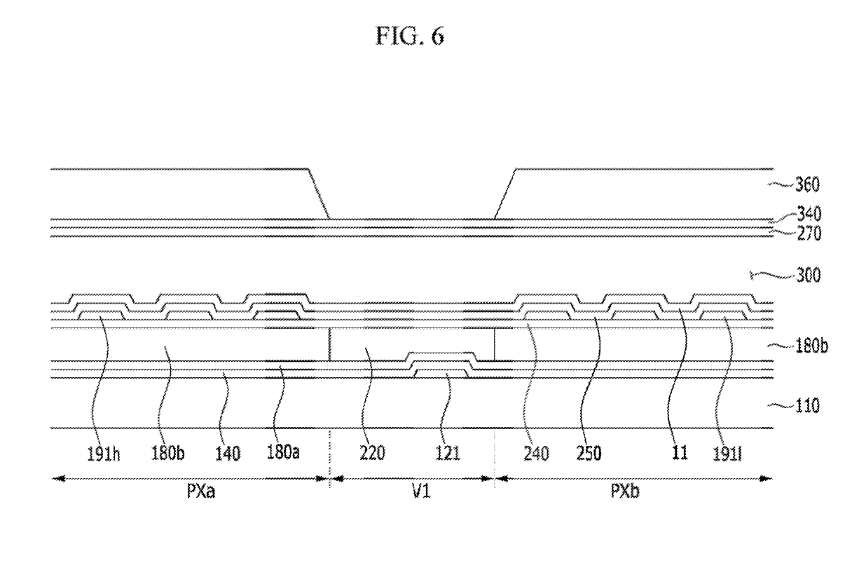

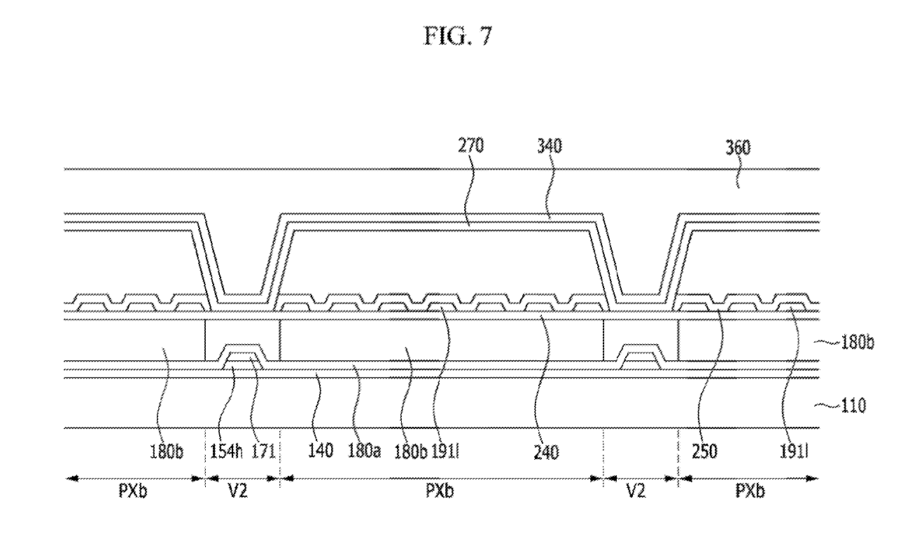

As shown in FIGS. 6 and 7, a photosensitive organic material is coated on the second insulating layer 250, and a sacrificial layer 300 is formed by a photo process.

The sacrificial layer 300 is formed to be connected along a plurality of columns. That is, the sacrificial layer 300 is formed to cover each pixel PX and to cover the first valley V1 disposed between the first subpixel PXa and the second subpixel PXb.

Next, a common electrode 270 is formed by depositing a transparent metal material such as indium tin oxide (ITO) and indium zinc oxide (IZO) on the sacrificial layer 300.

Next, a third insulating layer 340 may be formed on the common electrode 270 by using an inorganic insulating material such as a silicon nitride, a silicon oxide (SiOx), and a silicon nitride oxide (SiOxNy).

Next, the roof layer 360 is formed by coating and patterning an organic material on the third insulating layer 340. In this case, the organic material disposed in the first valley V1 may be patterned to be removed. As a result, the roof layers 360 may be formed to be connected to each other along a plurality of pixel rows.

In the meantime, the roof layers 360 are not disposed in the first valley areas, and the roof layers 360 are spaced apart from each other with the valley area therebetween. Accordingly, a roof layer adjacent to a valley area is formed to have an inclined surface.

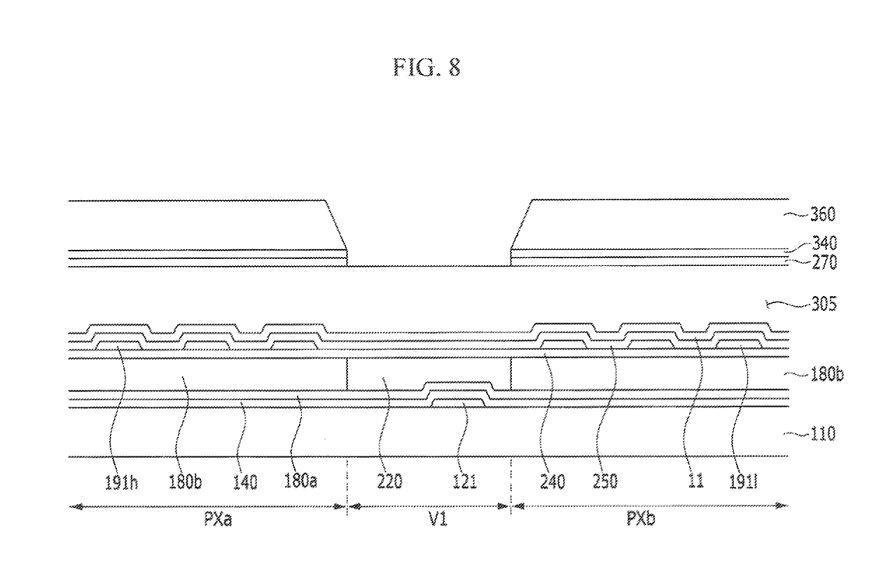

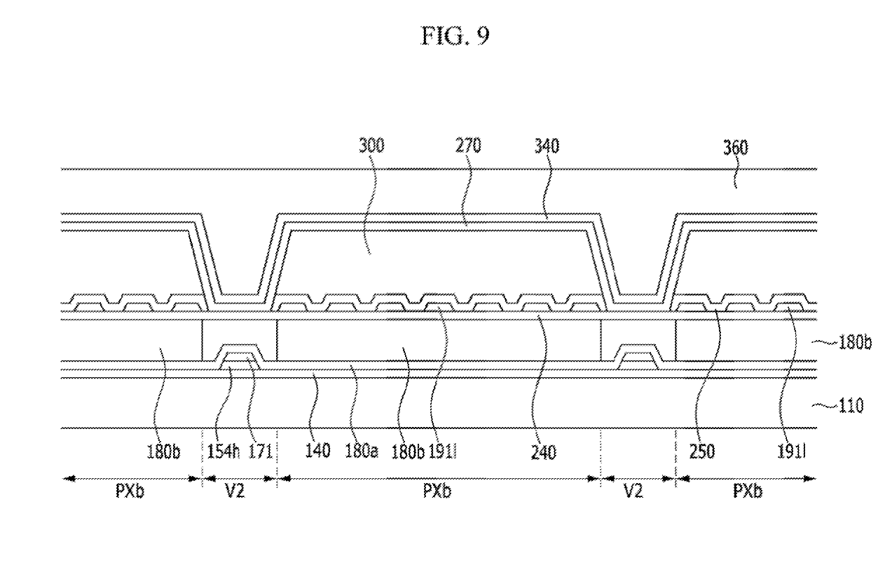

Next, as shown in FIGS. 8 and 9, the third insulating layer 340 and the common electrode 270 are patterned by using the roof layer 360 as a mask. First, the third insulating layer 340 is dry etched by using the roof layer 360 as a mask, and then the common electrode 270 is wet etched.

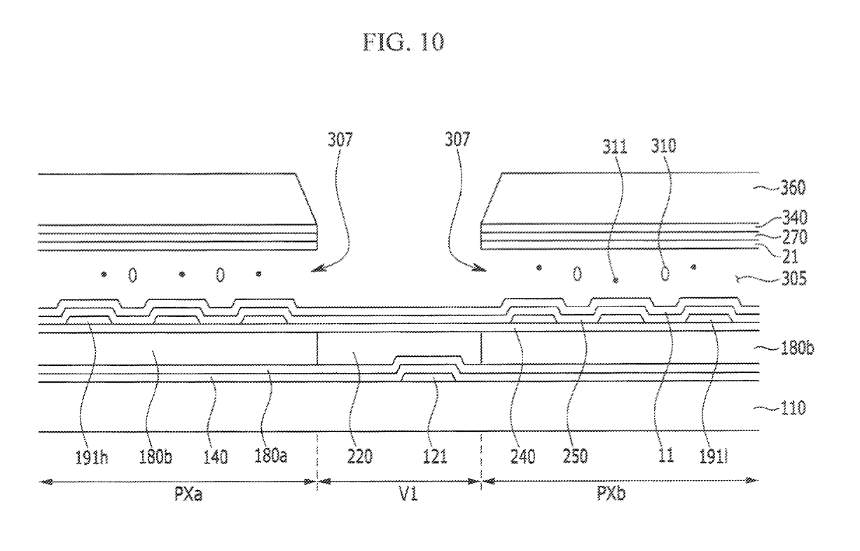

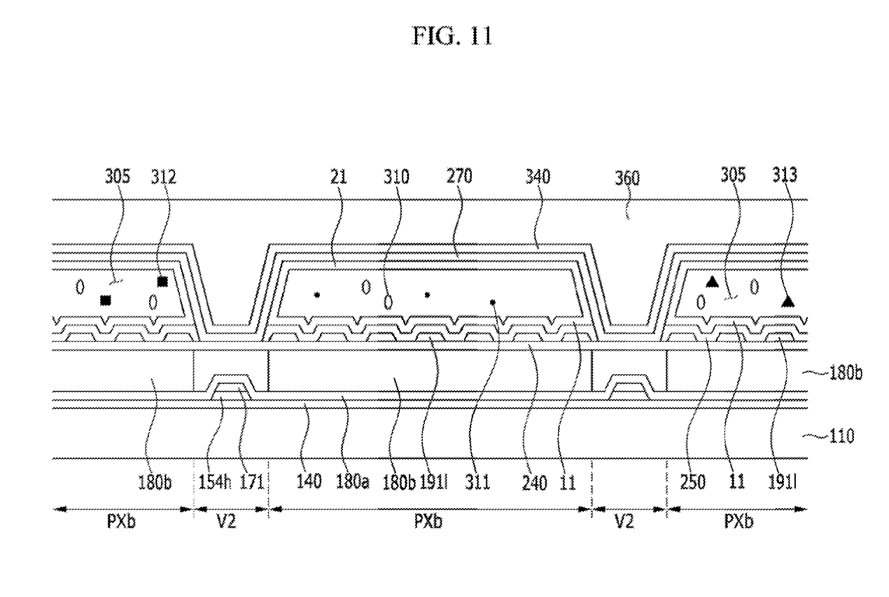

Next, as shown in FIGS. 10 and 11, the sacrificial layer 300 is completely removed by supplying a developer or a striper solution on the substrate 110 in which the sacrificial layer 300 is exposed, or by using an ashing process.

When the sacrificial layer 300 is removed, the microcavity 305 is formed at a region at which the sacrificial layer 300 was disposed.

The pixel electrode 191 and the common electrode 270 are spaced apart from each other with the microcavity 305 therebetween, and the pixel electrode 191 and the roof layer 360 are spaced apart from each other with the microcavity 305 therebetween. The common electrode 270 and the roof layer 360 are formed to cover an upper surface and both lateral surfaces of the microcavity 305.

The microcavity 305 is exposed to the outside through a region in which the roof layer 360, the third insulating layer 340, and the common electrode 270 are removed, which is referred to as the injection hole 307. The injection hole 307 is formed along the first valley V1. For example, the injection holes 307 may be formed to face each other at edges of the first subpixel PXa and the second subpixel PXb. That is, the injection hole 307 may be formed to expose lateral surfaces of the microcavity 305 to correspond to a lower side of the first subpixel PXa and an upper side of the second subpixel PXb. In other embodiments, the injection hole 307 may be formed along the second valley V2.

Subsequently, the roof layer 360 is cured by applying heat to the substrate 110. This is for the purpose of maintaining the shape of the microcavity 305 by the roof layer 360.

Subsequently, when an alignment agent including an alignment material is dripped on the substrate 110 by a spin coating method or an inkjet method, the alignment agent is injected into the microcavity 305 through the injection hole 307. When a curing process is performed after the aligning agent is injected into the microcavity 305, a solution component is vaporized and the alignment material remains at an inner wall surface of the microcavity 305.

Accordingly, the first alignment layer 11 may be formed on the pixel electrode 191, and the second alignment layer 21 may be formed below the common electrode 270. The first alignment layer 11 and the second alignment layer 21 are formed to face each other with the microcavity 305 therebetween, and are formed to be connected to each other at the edge of the pixel PX.

In this case, the first and second alignment layers 11 and 21 may be aligned in a direction that is perpendicular to the insulating substrate 110, except for the lateral surface of the microcavity 305. The first and second alignment layers 11 and 21 may be aligned in a direction that is parallel to the insulating substrate 110 by additionally irradiating UV to the first and second alignment layers 11 and 21.

Subsequently, when the liquid crystal material formed of the liquid crystal molecules 310 is dripped on the substrate 110 by an inkjet method or a dispensing method, the liquid crystal material is injected into the microcavity 305 through the injection hole 307.

The liquid crystal material of the display device according to the exemplary embodiment of the present invention includes the liquid crystal molecules 310 and the color materials 311, 312, and 313 mixed with the liquid crystal molecules. The color materials 311, 312, and 313 are mixed with the liquid crystal material, and each of the color materials 311, 312, and 313 may be a pigment representing at least one of primary colors of red, green, and blue.

Accordingly, the pigments 311, 312, and 313 with different colors are respectively applied to the microcavities 305, such that light passing through each of the microcavities 305 may represent a color corresponding to each of the pigments 311, 312, and 313. That is, when colors of the pigments 311, 312, and 313 are respectively red, green, and blue, the liquid crystal layers included in the microcavities 305 may respectively represent the red, green, and blue colors.

The pigments 311, 312, and 313 may be an inorganic pigment or an organic pigment, but is not limited thereto, and thus may be any pigment that is able to represent a predetermined color.

Further, a microcavity 305 representing a white color may be formed by including the pigments 311, 312, and 313 with only primary colors of red, green, and blue.

The color materials 311, 312, and 313 may include dichroic dyes having anisotropy in absorption of light, instead of the pigments with the colors described above.

Colors represented by the dichroic dyes 311, 312, and 313 are determined by a spectrum with respect to colors that are not absorbed by the dichroic dyes 311, 312, and 313, that is, complementary colors. Accordingly, when any pixel is intended to display one of primary colors of red, green, and blue, the dichroic dye 311, 312, or 313 included in the liquid crystal layer corresponding to the pixel may be a material absorbing light of a wavelength region corresponding to one of cyan, magenta, and yellow. For example, each of liquid crystal layers corresponding to a red pixel, a green pixel, and a blue pixel may include a liquid crystal material in which a cyan dichroic dye, a magenta dichroic dye, and yellow dichroic dye 311, 312, and 313 are respectively mixed. In this case, the cyan dichroic dye may absorb light of a wavelength region of 600-700 nm, the magenta dichroic dye may absorb light of a wavelength region of 500-580 nm, and the yellow dichroic dye may absorb light of a wavelength region of 430-490 nm.

Unlike this, when any pixel displays one of cyan, magenta, and yellow, the dichroic dye 311, 312, or 313 included in the liquid crystal layer corresponding to the pixel may be a material absorbing light of a wavelength region corresponding to one of red, green, and blue.

Further, a microcavity 305 representing a white color may be formed by including the pigments 311, 312, and 313 with only primary colors of red, green, and blue.

The dichroic dyes 311, 312, and 313, for example, may include one or more selected from azo dyes, anthraquinone dyes, perylene dyes, merocyanine dyes, azomethine dyes, phthaloperylene dyes, indigo dyes, dioxadine dyes, polythiophene dyes, and phenoxazine dyes, but are not limited thereto.

An appropriate concentration of the dichroic dyes 311, 312, and 313 mixed with the liquid crystal material may be varied depending on an absorption capacity of light of the dichroic dyes 311, 312, and 313.

The dyes 311, 312, and 313 are not limited to those described above, and may include materials which pass through light of some specific wavelengths and which reflect light of the other wavelengths. In other words, a liquid crystal layer filled inside a microcavity 305 corresponding to a pixel representing a red color may include a material that passes through only light of a red wavelength band and reflects light of the remaining wavelength band. Further, a liquid crystal layer filled inside a microcavity 305 corresponding to a pixel representing a green color may include a material that passes through only light of a green wavelength band and reflects light of the remaining wavelength band. In addition, a liquid crystal layer filled inside a microcavity 305 corresponding to a pixel representing a blue color may include a material that passes through only light of a blue wavelength band and reflects light of the remaining wavelength band.

According to the exemplary embodiment of the present invention, since the color of the pixel is implemented by the color pigment or the dichroic color dye that is injected into the liquid crystal layer, or by the material that passes through light of some specific wavelengths, a color filter is not required. Accordingly, a photolithography process for forming the color filter is not required, thereby simplifying a structure of the display device, and reducing manufacturing processes, time, and cost.

In a vertical direction of the microcavity 305, the liquid crystal material including corresponding color materials 311, 312, and 313 that can display corresponding colors is injected into the microcavity 305 through the injection holes 307 formed at opposite sides of the microcavity 305. In a horizontal direction of the microcavity 305, the liquid crystal materials including different kinds of color materials 311, 312, and 313 that can display different colors are repeatedly injected into the adjacent microcavities 305 through the injection holes 307 with a predetermined cycle (e.g., repetition of red, green, and blue). A nozzle injecting the liquid crystal materials including the different kinds of color materials 311, 312, and 313 may drip the liquid crystal material including the color materials 311, 312, and 313, for example, moving in a vertical direction. In this case, the injecting process for each color may be sequentially performed with a time interval such that the liquid crystal materials including the different kinds of the color materials 311, 312, and 313 may not be mixed, the injecting processes may be simultaneously performed by adjusting a spread of the liquid crystal material including the color materials 311, 312, and 313, or the two injecting processes may be combinatorially performed.

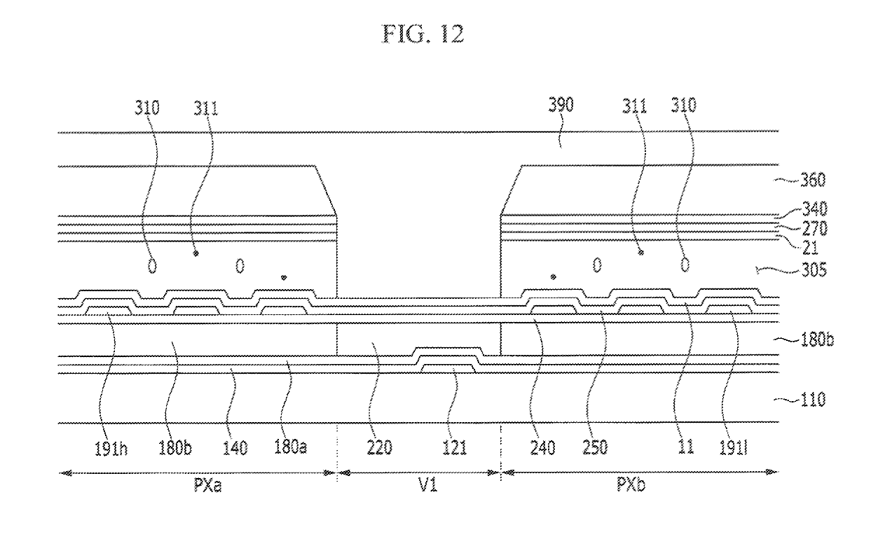

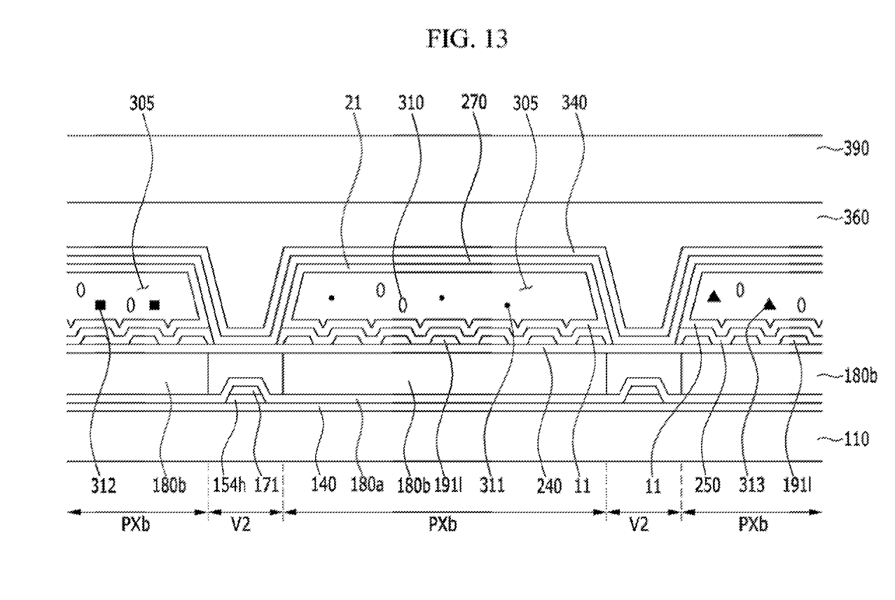

Next, as shown in FIGS. 12 and 13, the overcoat 390 is formed at the entire surface of the substrate 110 by depositing a material that does not react with the liquid crystal molecules 310 on the roof layer 360. The overcoat 390 is formed to cover the injection hole 307 where the microcavity 305 is exposed outside to seal the microcavity 305.

Although not illustrated, polarizers may be further formed on the upper and lower surfaces of the display device. The polarizers may be formed as a first polarizer and a second polarizer. The first polarizer may be attached to the lower surface of the substrate 110, and the second polarizer may be attached to the overcoat 390.

As described above, according to the exemplary embodiments of the present invention, it is possible to simplify a structure of the display device and may reduce the number of manufacturing processes thereof by adding a color material to a liquid crystal material of the display device manufactured with a single substrate such that a color filter may be removed.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

### DESCRIPTION OF SYMBOLS

11: first alignment layer 21: second alignment layer

110: insulation substrate 121: gate line

124h: first gate electrode 124l: second gate electrode

124c: third gate electrode 131: storage electrode line

140: gate insulating layer 171: data line

191: pixel electrode 191h: first subpixel electrode

191l: second subpixel electrode 220: light blocking member

180: passivation layer 240: first insulating layer

270: common electrode 300: sacrificial layer

305: microcavity 307: injection hole

310: liquid crystal molecule 250: second insulating layer

370: third insulating layer 390: overcoat

311, 312, 313: dye

What is claimed is:

1. A display device, comprising:
a substrate including a plurality of pixels formed in row and column directions;
a thin film transistor disposed on the substrate, and a pixel electrode connected to the thin film transistor;
a first liquid crystal layer filled inside a microcavity formed on the pixel electrode;
a plurality of roof layers formed to be separated from the pixel electrode with the microcavity and an injection hole therebetween; and
an overcoat formed on the roof layer to cover the injection hole and encapsulate the microcavity,
wherein the first liquid crystal layer includes a liquid crystal molecule and a color material.

2. The display device of claim 1, wherein
the color material includes a red, green, or blue pigment.

3. The display device of claim 2, wherein
first liquid crystal layers that are adjacent in the row direction include different color pigments, and
first liquid crystal layers that are adjacent in the column direction include the same color pigment.

4. The display device of claim 2, wherein
the pigment includes an inorganic or organic pigment.

5. The display device of claim 2, further comprising
a second liquid crystal layer containing only liquid crystal molecules,
wherein the second liquid crystal layer displays a white color.

6. The display device of claim 1, wherein
the color material includes a dichroic dye having predetermined anisotropy.

7. The display device of claim 6, wherein
the dichroic dye includes a material absorbing a wavelength region corresponding to one of cyan, magenta, yellow, red, green, and blue.

8. The display device of claim 7, wherein
the dichroic dye includes one or more selected from azo dyes, anthraquinone dyes, perylene dyes, merocyanine dyes, azomethine dyes, phthaloperylene dyes, indigo dyes, dioxadine dyes, polythiophene dyes, and phenoxazine dyes.

9. The display device of claim 1, wherein
the color material includes a material that transmits light having a red, green, or blue wavelength, and reflects light having other wavelengths.

10. A manufacturing method of a display device, comprising:
forming a thin film transistor on a substrate;
forming a pixel electrode connected to the thin film transistor on the thin film transistor;
forming a sacrificial layer on the pixel electrode;
forming a roof layer that includes an injection hole formed by coating and patterning an organic material on the sacrificial layer;
forming a microcavity between the roof layer and the pixel electrode by removing the sacrificial layer;
forming a first liquid crystal layer by injecting a first liquid crystal material in the microcavity through the injection hole; and
forming an overcoat on the roof layer to cover the injection hole and encapsulate the microcavity,
wherein the first liquid crystal material includes a liquid crystal molecule and a color material.

11. The manufacturing method of claim 10, wherein the color material includes a red, green, or blue pigment.

12. The manufacturing method of claim 11, wherein
the first liquid crystal materials of the first liquid crystal layers that are adjacent in a row direction include different color pigments, and
the first liquid crystal materials of the first liquid crystal layers that are adjacent in a column direction include the same color pigment.

13. The manufacturing method of claim 11, wherein
the pigment includes an inorganic or organic pigment.

14. The manufacturing method of claim 11, further comprising
forming a second liquid crystal layer by injecting a second liquid crystal material including only a liquid crystal molecule in the microcavity through the injection hole,
wherein the second liquid crystal layer displays a white color.

15. The manufacturing method of claim 10, wherein
the color material includes a dichroic dye having predetermined anisotropy.

16. The manufacturing method of claim 15, wherein
the dichroic dye includes a material absorbing a wavelength region corresponding to one of cyan, magenta, yellow, red, green, and blue.

17. The manufacturing method of claim 16, wherein
the dichroic dye includes one or more selected from azo dyes, anthraquinone dyes, perylene dyes, merocyanine dyes, azomethine dyes, phthaloperylene dyes, indigo dyes, dioxadine dyes, polythiophene dyes, and phenoxazine dyes.

18. The manufacturing method of claim 10, wherein
the color material includes a material that transmits light having a red, green, or blue wavelength, and reflects light having other wavelengths.

19. The manufacturing method of claim 10, further comprising
forming a common electrode on the sacrificial layer before forming the roof layer.
